(19) United States
(12) Patent Application Publication
(10) Pub. No.: US 2008/0203229 A1
(43) Pub. Date: Aug. 28, 2008

(54) Windblocker For Use In Aircraft

(76) Inventors: Andre Herbst, Halstenbek (DE); Udo Fehrs, Uetersen (DE)

Correspondence Address: ROBERT W. BECKER & ASSOCIATES, 707 HIGHWAY 333, SUITE B, TIJERAS, NM, 87059-7507, US

(21) Appl. No.: 11/814,795

(22) PCT Filed: Jan. 24, 2006
(86) PCT No.: PCT/EP06/00570

§ 371 Date: Jul. 25, 2007

(30) Foreign Application Priority Data
Jan. 25, 2005 (DE) 10 2005 003 518.3

(51) Int. Cl. B64C 1/14

(52) U.S. Cl. 244/129.1

(57) ABSTRACT

A windblocker adapted to be anchored in the interior of an aircraft, comprising a tensioning device adapted to be centrally disposed in a cross-sectional area of the interior of the aircraft, securing straps that extend radially from the tensioning device to mounting points provided on a load-bearing skeleton of the aircraft and adapted to be secured to the mounting points when the windblocker is installed in the aircraft interior, and fabric segments supported on the supporting straps and filling spaces provided between the securing straps.

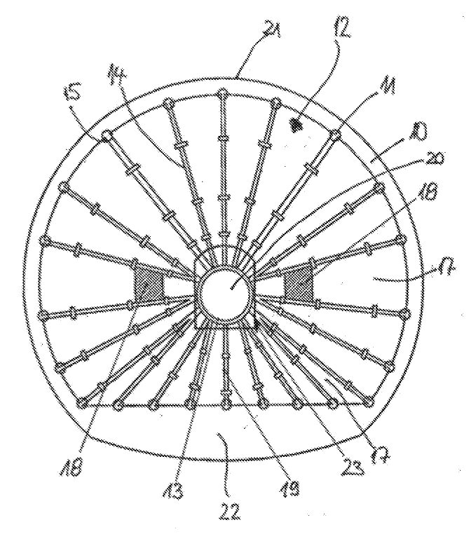

The present invention relates to a windblocker that can be anchored in the interior of an aircraft.

To the extent that an aircraft is used for dropping or depositing not only cargo but also personnel by parachute, with the simultaneous opening of a cargo drop hatch generally disposed in the rear, as well as of doors for dropping personnel and disposed in the longitudinal portion of the aircraft fuselages considerable air streams result in the interior of the aircraft that equally disrupt both drop processes and can represent a corresponding risk for a rapid and smooth drop process.

It is therefore an object of the present invention to make available a device that interrupts the air stream that develops in the interior of the aircraft during the drop process, and which is easy and rapid to install in or remove from the interior of the aircraft and also saves space for storage thereof.

The realization of this object, including advantageous embodiments and further developments of the invention, result from the content of the patent claims, which follow this description.

The basic concept of the present invention is a windblocker that is comprised of a fabric, preferably a textile fabric, and with which securing strips extend radially, from a tensioning device that is to be disposed centrally in the cross-section area of the interior, to mounting points provided on the load-bearing skeleton of the aircraft and are to secured to the mounting points when the windblocker is installed, and whereby fabric segments are supported on the securing straps and fill the space between the securing straps.

The invention has the advantage that by means of the windblocker suspended in the interior of the aircraft, an air stream is prevented from passing through between various opened exit openings in an aircraft. Since the windblocker is comprised of a fabric, the windblocker requires little space for storage, and is easy and rapid to handle during assembly. In this connection, it is merely necessary to secure the free ends of the correspondingly provided securing straps to the mounting points of the aircraft designed therefor, and to stretch the securing straps by actuating the central tensioning device. In this connection, all of the fastening means as well as the fabric used are designed in a suitable manner such that the windblocker resist or withstands the active flow forces.

Due to the radially extending securing straps, with regard to the shape of the fabric segments pursuant to one specific embodiment of the invention these segments have a triangular to trapezoidal shape.

The outer side of the fabric segments opposite or remote from the to tensioning device can be connected to the inner wall of the aircraft body, whereby the fabric segments are preferably sealingly connected to the inner wall of the aircraft body in order to the extent possible to return an air stream that correspondingly occurs at the inner periphery of the aircraft body.

Pursuant to embodiments of the inventions the connection of the fabric segments to the inner wall of the aircraft body can alternatively be realized by means of a Velcro-type fastener, a snap-button fastener, or a hook and eye fastener. The fabric segments can also be connected to a circumferential, inflatable hose or tube that in the position of use rests against the inner wall of the aircraft body.

To the extent that in particular also in the region of the base of the aircraft body a certain sealing is to be provided, pursuant to one embodiment of the invention the fabric segments that abut the region of the base of the vehicle body are sealed relative to the region of the base by a contacting heavy, water-impervious fabric.

With regard to the configuration of the central tensioning device, pursuant to one embodiment of the invention the central tensioning device is embodied as a ring, the diameter of which can be varied, to whereby the ring can be embodied, for example, as a flexible adhesive or lasso loop that can contract upon activation, or the ring can be embodied as a rigid annular body having at least two ring segments that are movable relative to one another, whereby the ring segments can preferably be configured so as to be displaceable within one another. To the extent that the remaining central opening in the ring of the tensioning device requires sealing, the opening can be formed by a flexible valve element, for example in the form of a fabric flap that in the case where the overpressure is too great, is forced through the opening and to this extent exposes the opening for pressure equalization.

To be able to ensure that for example a person located on that side of the suspended windblocker remote from the cargo drop hatch can observe the drop process through the cargo drop hatch, pursuant to an embodiment of the invention a window made of transparent material is disposed in at least one of the fabric segments.

To the extent that personnel must be able to move between the two compartments of the aircraft interior that are separated by the windblocker, at least one fabric segment can be opened and closed by to a zipper or slide fastener, whereby pursuant to one embodiment the fabric segment that contains the zipper extends between the central tensioning device and the region of the base of the aircraft body.

Pursuant to one embodiment of the invention, the securing straps can be embodied V-shaped straps, the outer free-ends of which can be supported on the mounting points of the aircraft body, whereby the securing straps extend in a loop through the central tensioning device; this ensures that the tensioning movement of the securing straps is completed without problem.

Pursuant to an embodiment of the invention, the securing straps can be embodied as straps that can be altered in length in order to enable adaptation to different aircraft dimensions.

To the extent that functional components such as cables and/or lines of holding or retention devices for the cargo being transported extend along the aircraft body, pursuant to an embodiment of the invention openings can be provided in the fabric segments for running such components through, whereby pursuant to an embodiment of the to invention the openings for running the components through can be cut out of the outer edge region of the fabric segments. Corresponding to the sealing of the central opening of the tensioning device, the openings for running the components through can also be sealed by flexible valve elements.

To ensure a space-saving support of the windblocker pre-mounted in the interior of an aircraft, pursuant to an embodiment of the invention on the securing straps that lead to the region of the roof of the aircraft it is possible to additionally provide suspension eyes or loops for supporting the windblocker, which is rolled up to the suspension eyes or loops; with this embodiment, it is possible to loosen the plurality of securing straps connected to the region of the base as well as to the side regions of the aircraft fuselage and to roll the windblocker up toward the region of the roof and to secure the thus-formed roll by means of the suspension eyes or loops that are provided.

With regard to the partitioning function, the fabric used for the fabric segments can be a textile, air-impervious fabric.

However, with regard to the partitioning function it can be sufficient if the fabric utilized is a fabric having low to moderate permeability; the to use of narrow-meshed netting is also not precluded.

The present invention also envisions allotting further functions to the windblocker, for which purpose the fabric used for the fabric segments can be composed of several fabric plies having different functions. For example, one fabric ply can be designed for insulation against cold or heat and/or for electromagnetic screening and/or to protect against fire and/or smoke.

The drawing shows one embodiment of the invention, which will be described subsequently.

The sole FIGURE, in a schematic cross-sectional view, shows an aircraft fuselage having a windblocker suspended therein.

To the extent that an aircraft fuselage 10 is illustrated in the drawing, fastening or mounting points 11 are distributed over its periphery, and in particular in the region of the roof 21 and also in the region of the base 22, as well as in the side regions disposed there between, and these mounting points are disposed on the load-bearing skeleton of the aircraft fuselage 10 in such a way that forces introduced into the mounting points 11 are absorbed by the supporting skeleton of the aircraft fuselage 10. The cross-sectional area of the interior of the to aircraft defined by the aircraft fuselage illustrated in the drawing is covered by a stretched-on or suspended windblocker 12. The windblocker 12 is comprised of tensioning or securing straps 14 that proceed in a star-shaped or radial manner from a ring 13 that is to be centrally disposed in the cross-sectional area of the interior space. The lengths of the securing straps 14 can be altered, and the securing straps extend to the mounting points 11j the free ends (15) of the securing straps 14 are respectively connected to the mounting points 11.

The triangular space respectively disposed between the securing straps 14 is filled by fabric segments 17 comprised of a preferably textile or woven fabric, whereby the fabric segments 17 are respectively connected to the securing straps 14 in a suitable manner. In the illustrated embodiment, disposed in two of the segments 17 that lead from the central ring 13 to the side regions of the aircraft fuselage 10 are windows 18, produced by using a transparent material, so that operating personnel that are on one side of the windblocker 12 can observe movement on the other side of the windblocker 12. To provide easy passage through the windblocker 12, a zipper or slide fastener 19 extends from the central ring 13 to the region of the base 22 of the aircraft fuselage (10). When this zipper 19 is opened, personnel can to slip through the windblocker 12.

To the extent that the central ring 13 has a central opening 20, the latter is covered by a flap-like textile element 23 that can be forced through the opening 20 to equalize pressure when a corresponding stress is encountered.

The features of the subject matter of these documents disclosed in the preceding specification, the patent claims the abstracts and the drawing can be important individually as well as in any combination with one another for realizing the various embodiments of the invention.

1-28. (canceled)

29. A windblocker adapted to be anchored in the interior of an aircraft, comprising:
a tensioning device (13) adapted to be centrally disposed in a cross-sectional area of the interior of the aircraft;
securing straps (14) that extend radially from the tensioning device (13) to mounting points (11) provided on a load-bearing skeleton of the aircraft and are adapted to be secured to the mounting points (11) when the windblocker (12) is installed in the aircraft interior, and fabric segments (17) supported on the securing straps (14) and filling spaces provided between the securing straps.

30. A windblocker according to claim 29, wherein the fabric segments (17) have a triangular to trapezoidal shape.

31. A windblocker according to claim 29, wherein an outer side of the fabric segments (17) opposite the tensioning device (13) is connected to an inner wall of a fuselage (10) of the aircraft.

32. A windblocker according to claim 31 wherein the fabric segments (17) are sealingly connected to the inner wall of the aircraft fuselage (10).

33. A windblocker according to claim 31, wherein the connection of the fabric segments (17) to the inner wall of the aircraft fuselage (10) is provided by means of a Velcro-type fastener, a snap-button fastener, or a hook and eye fastener.

34. A windblocker according to claim 31, wherein the fabric segments (17) are connected to a circumferential, inflatable hose or tube that in a position of use rests against the inner wall of the aircraft fuselage (10).

35. A windblocker according to according to claim 32, wherein those fabric segments (17) that abut against a base region (22) of the aircraft fuselage (10) are sealed relative to the base region by mean of a contacting, heavy, water-impervious fabric.

36. A windblocker according to claim 29, wherein said tensioning device (13) is embodied as a ring, the diameter of which is adapted to be varied.

37. A windblocker according to claim 36, wherein the ring (13) is embodied as a flexible adhesive or lasso loop, or as a rigid annular body having at least two ring segments that are movable relative to one another.

38. A windblocker according to claim 36, wherein a central opening (20) remains in the ring (13), and wherein a flexible valve element (23) is provided for sealing the remaining central opening (20).

39. A windblocker according to claim 29, wherein a window (18) made of transparent material is disposed in at least one of said fabric segments (17).

40. A windblocker according to claim 29, wherein at least one zipper or slide fastener (19) is provided, and wherein at least one of the fabric segments (17) is opened and closed by the least one zipper or slide fastener (19).

41. A windblocker according to claim 40, wherein the at least one fabric segment (17) that contains the at least one zipper or slide fastener (19) extends between the tensioning device (13) and a base region (22) of a fuselage (10) of the aircraft.

42. A windblocker according to claim 29, wherein the securing straps (14) are embodied as V-shaped straps having outer free ends that are adapted to be supported on the mounting points (11) of the aircraft skeleton, and wherein the securing straps (14) extend in a loop through the tensioning device (13).

43. A windblocker according to claim 29, wherein the securing straps (14) are embodied as straps that are adapted to be varied in their length.

44. A windblocker according to claim 29, wherein openings are provided in the fabric segments (17) for running functional components through that extend along a fuselage (10) of the aircraft.

45. A windblocker according to claim 44, wherein the openings for the running through of components are cut out of an outer edge region of the fabric segments (17).

46. A windblocker according to claim 44, wherein the openings for the running through of components are sealed by flexible valve elements.

47. A windblocker according to claim 29, wherein securing straps (14) that lead to a roof region (21) of the aircraft are provided with suspension eyes or loops for supporting the windblocker (12) that is rolled up to the suspension eyes or loops.

48. A windblocker according to claim 29, wherein the fabric used for the fabric segments (17) is a textile, air-impervious fabric, or a fabric having low to moderate permeability, or a fabric composed of several fabric plies having different functions.

49. A windblocker according to claim 48, wherein one fabric ply is designed for insulation against cold or heat, or is designed for electromagnetic screening, or is designed to protect against fire and/or smoke.
